(19) United States
(12) Patent Application Publication
(10) Pub. No.: US 2022/0167036 A1
(43) Pub. Date: May 26, 2022

(54) LIVE BROADCAST METHOD AND APPARATUS, AND COMPUTER DEVICE AND STORAGE MEDIUM

(71) Applicant: GUANGZHOU HUYA INFORMATION TECHNOLOGY CO., LTD., Guangdong (CN)

(72) Inventor: Taiyu Lin, Guangdong (CN)

(73) Assignee: GUANGZHOU HUYA INFORMATION TECHNOLOGY CO., LTD., Guangdong (CN)

(21) Appl. No.: 17/600,980

(22) PCT Filed: Apr. 3, 2020
(86) PCT No.: PCT/CN2020/083123

§ 371 Date: Oct. 1, 2021

(30) Foreign Application Priority Data
Apr. 3, 2019 (CN) 201910266780.7

(51) Int. Cl. H04N 21/258; H04N 21/2187; H04N 21/431

(52) U.S. Cl. CPC H04N 21/25875; H04N 21/4312; H04N 21/2187

(57) ABSTRACT

Provided are a live broadcast method and apparatus, a computer device, and a storage medium. The live broadcast method is applied to a virtual application, which is configured to display a virtual scene and play first audio data. The method includes generating a first user code for the virtual application; acquiring a second user code from a live broadcast platform, where the first user code is bound to the second user code; logging in to the live broadcast platform according to the second user code, so as to open a live broadcast room bound to the second user code; and sending live broadcast stream data to the live broadcast platform for playing in the live broadcast room, where the live broadcast stream data includes the virtual scene displayed by the virtual application, the first audio data played by the virtual application, and second audio data recorded by a microphone.

### CROSS-REFERENCE TO RELATED APPLICATIONS

This is a National Stage Application filed under 35 U.S.C. 371 based on International Patent Application No. PCT/CN2020/083123, filed on Apr. 3, 2020, which claims priority to Chinese Patent Application No. 201910266780.7 filed on Apr. 3, 2019, disclosures of both of which are incorporated herein by reference in their entireties.

### TECHNICAL FIELD

The present application relates to live broadcast technologies, for example, a live broadcast method and apparatus, a computer device, and a storage medium.

### BACKGROUND

With the rapid development of live broadcast technologies such as the popularization of mobile terminals, an anchor user can set up a live broadcast room on a live broadcast platform to host a live broadcast at any time, attracting a large number of viewer users to enter the live broadcast room to watch the live broadcast.

In the related art, the user often installs virtual applications such as a virtual social application, a 3D map application, and a game application in the mobile terminal, so as to satisfy the requirements of the user for work, entertainment, and social interaction.

These virtual applications are independent applications. If the anchor user wants to broadcast a virtual scene in the virtual application, the anchor user needs to install a live broadcast application in the mobile terminal, start the virtual application and the live broadcast application, and log in to the virtual application and the live broadcast application, respectively. The virtual application runs at a front end for the anchor user to operate, and the live broadcast application runs in the background to collect video data and audio data and push the same to the live broadcast platform.

### SUMMARY

The present application provides a live broadcast method and apparatus, a mobile terminal, and a storage medium.

Embodiments of the present application provide a live broadcast method applied to a virtual application, where the virtual application is configured to display a virtual scene and play first audio data; where the method includes steps described below. A first user code is generated for the virtual application. A second user code is acquired from a live broadcast platform, where the first user code is bound to the second user code. The live broadcast platform is logged in according to the second user code, so as to open a live broadcast room bound to the second user code. Live broadcast stream data is sent to the live broadcast platform for playing in the live broadcast room, where the live broadcast stream data includes the virtual scene displayed by the virtual application, the first audio data played by the virtual application, and second audio data recorded by a microphone.

The embodiments of the present application further provide a live broadcast method applied to a live broadcast platform, where the method includes steps described below. A first user code sent by a virtual application is received, where the virtual application is configured to display a virtual scene and play first audio data, and the first user code belongs to the virtual application. A second user code is sent to the virtual application, where the second user code belongs to the live broadcast platform, and the first user code is bound to the second user code. A login operation is executed based on the second user code, so as to open a live broadcast room bound to the second user code. Live broadcast stream data sent by the virtual application is received, where the live broadcast stream data includes the virtual scene displayed by the virtual application, the first audio data played by the virtual application, and second audio data recorded by a microphone, and the live broadcast stream data is used for playing in the live broadcast room.

The embodiments of the present application further provide a live broadcast apparatus applied to a virtual application, where the virtual application is configured to display a virtual scene and play first audio data; where the apparatus includes a first user code generation module, a second user code acquisition module, a live broadcast platform login module, and a live broadcast stream data sending module. The first user code generation module is configured to generate a first user code for the virtual application. The second user code acquisition module is configured to acquire a second user code from a live broadcast platform, where the first user code is bound to the second user code. The live broadcast platform login module is configured to log in to the live broadcast platform according to the second user code, so as to open a live broadcast room bound to the second user code. The live broadcast stream data sending module is configured to send live broadcast stream data to the live broadcast platform for playing in the live broadcast room, where the live broadcast stream data includes the virtual scene displayed by the virtual application, the first audio data played by the virtual application, and second audio data recorded by a microphone.

The embodiments of the present application further provide a live broadcast apparatus applied to a live broadcast platform, where the apparatus includes a first user code receiving module, a second user code sending module, a login operation execution module, and a live broadcast stream data receiving module. The first user code receiving module is configured to receive a first user code sent by a virtual application, where the virtual application is configured to display a virtual scene and play first audio data, and the first user code belongs to the virtual application. The second user code sending module is configured to send a second user code to the virtual application, where the second user code belongs to the live broadcast platform, and the first user code is bound to the second user code. The login operation execution module is configured to execute a login operation based on the second user code, so as to open a live broadcast room bound to the second user code. The live broadcast stream data receiving module is configured to receive live broadcast stream data sent by the virtual application, where the live broadcast stream data includes the virtual scene displayed by the virtual application, the first audio data played by the virtual application, and second audio data recorded by a microphone, and the live broadcast stream data is used for playing in the live broadcast room.

The embodiments of the present application further provide a computer device. The computer device includes a memory, a processor, and a computer program stored in the memory and executable by the processor. The processor executes the computer program to implement the live broadcast method described above.

The embodiments of the present application further provide a non-transitory computer-readable storage medium storing a computer program, where the computer program is configured to, when executed by a processor, implement the live broadcast method described above.

In the embodiments of the present application, the first user code is generated for the virtual application, the second user code bound to the first user code is acquired from the live broadcast platform, the live broadcast platform is logged in according to the second user code, so as to open the live broadcast room bound to the second user code, and the live broadcast stream data is sent to the live broadcast platform for playing in the live broadcast room. The live broadcast stream data includes the virtual scene displayed by the virtual application, the first audio data played by the virtual application, and the second audio data recorded by the microphone. Live broadcast assemblies are embedded in the virtual application and can run when the virtual application runs, and the live broadcast can be carried out without installing an independent live broadcast application. It is easy to operate.

### BRIEF DESCRIPTION OF DRAWINGS

FIG. 1 is a flowchart of a live broadcast method according to embodiment one of the present application;

FIG. 2 is a flowchart of a live broadcast method according to embodiment two of the present application;

FIG. 3 is a flowchart of a live broadcast method according to embodiment three of the present application;

FIGS. 4A to 4D are exemplary views of a live broadcast interface according to an embodiment of the present application;

FIG. 5 is a flowchart of a live broadcast method according to embodiment four of the present application;

FIG. 6 is a flowchart of a live broadcast method according to embodiment five of the present application;

FIG. 7 is a structure diagram of a live broadcast apparatus according to embodiment six of the present application;

FIG. 8 is a structure diagram of a live broadcast apparatus according to embodiment seven of the present application; and

FIG. 9 is a structure diagram of a computer device according to embodiment eight of the present application.

### DETAILED DESCRIPTION

### Embodiment One

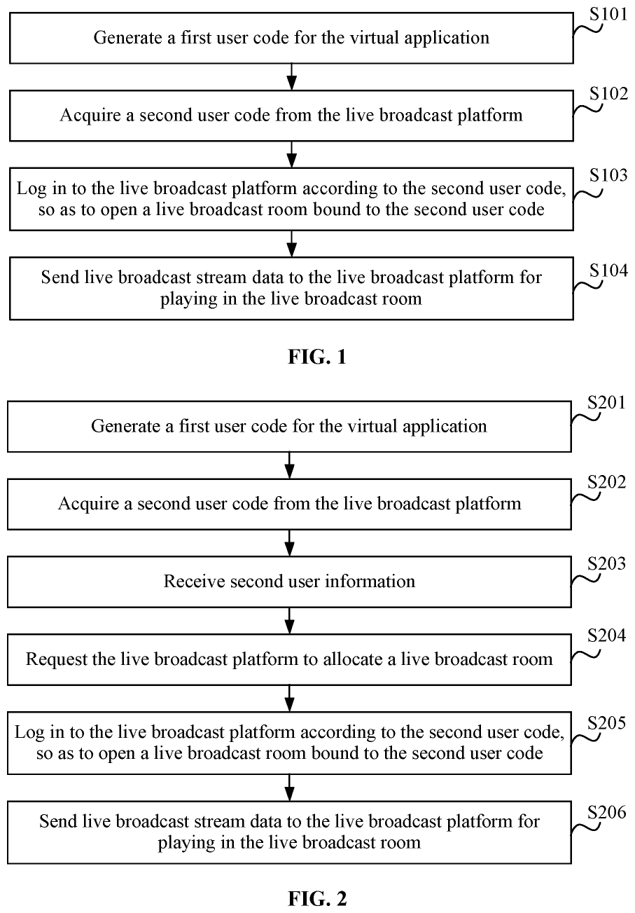

FIG. 1 is a flowchart of a live broadcast method according to embodiment one of the present application. This embodiment may be applied to a virtual application such as a virtual social application, a 3D map application, and a game application. According to service requirements, the virtual application may be configured to display a virtual scene and play first audio data, for example, to display a virtual town (the virtual scene) and to play related music (the first audio data) in the virtual social application, to display a virtual street and to play navigation audio (the first audio data) in the 3D map application, and to display a game screen (the virtual scene) and to play game music and user voice (the first audio data) in the game application, etc.

The virtual application is provided with live broadcast assemblies connectable to a live broadcast platform. The live broadcast assemblies may include independent live broadcast assemblies such as a software development kit (SDK), a plug-in, an applet, etc. These independent assemblies provide interfaces for the virtual application to call or may include built-in modules directly connected to the live broadcast platform so that the virtual application can quickly log in to the live broadcast platform for live broadcast.

The method may be executed by a live broadcast apparatus. The live broadcast apparatus may be implemented by software and/or hardware and may be configured in a mobile terminal such as a mobile phone, a tablet computer, a smart wearable device (such as smart glasses and a smart watch), etc. An operating system of the mobile terminal may include Android, IOS, Windows Phone, Windows, etc., which can support the operation of the live broadcast apparatus. The method includes steps described below.

In S101, a first user code is generated for the virtual application.

In the virtual application, the live broadcast assemblies may generate the first user code, where the first user code is configured to indicate a user that uses the virtual application.

During the implementation, an application identifier of the virtual application and a role identifier of a role in the virtual application are determined.

The application identifier is configured to indicate information of the virtual application in a virtual platform, such as an application ID. The application identifier is allocated to the application by the live broadcast platform when a manufacturer that develops the virtual application applies for access to the live broadcast platform.

For the same virtual application, the application identifier may distinguish information such as versions and platforms (such as Android and iOS) and may not distinguish the information such as versions and platforms, which is not limited in embodiments of the present application.

The role may be configured to indicate the user, the role identifier is configured to indicate information of the user that uses the virtual application, and the role application is generated based on specifications issued by the live broadcast platform.

In a case, a user account is logged in to the virtual application, and one or more virtual objects such as game characters may be set for the user account. The virtual objects may be manipulated by the user to complete corresponding virtual activities such as a multiplayer real-time battle, single-player role-playing and the like; or, one or more record archives may be set in a virtual game and different record archives are configured to record different progresses of the virtual activities.

In this case, each user account or each game archive in the virtual game may be configured to indicate the user, and then a corresponding role identifier can be set separately for each user account or each game archive.

In another case, the user account does not need to be logged in to the virtual game. In this case, the mobile terminal may indicate the user, and a corresponding role identifier may be set for the mobile terminal.

The preceding role identifier is only an example, and another role identifier may be set according to actual conditions during the implementation of the embodiments of the present application, which is not limited in the embodiments of the present application. In addition, in addition to the preceding role identifier, those skilled in the art may also use another role identifier according to actual requirements, which is not limited in the embodiments of the present application.

If the application identifier and the role identifier are determined, the first user code belonging to the virtual application is generated by using the application identifier and the role identifier through manners such as reordering, interpolation, and encryption.

During the implementation, since the role identifier is generated by the virtual application, to prevent the case where if the role identifiers are the same, the first user codes are the same, based on the application identifier and the role identifier, unique data may be added, so as to generate the first user code belonging to the virtual application.

Optionally, the first user code is information for the live broadcast platform to distinguish users that do not use the virtual application and is not necessarily an account of the virtual application. Therefore, for the live broadcast platform, the first user code belongs to a temporary code TempUid.

In S102, a second user code is acquired from the live broadcast platform.

In a live broadcast application, the live broadcast assemblies may generate the second user code, where the second user code is configured to indicate the user that uses the live broadcast platform.

The first user code is bound to the second user code so that an account system in the virtual application can communicate with an account system in the live broadcast platform.

In a case, the user previously had the second user code of the live broadcast platform, the second user code has been bound to the first user code, and the live broadcast has already started. In this case, the user logs in to the live broadcast platform based on the same first user code, and the live broadcast assemblies can send the first user code to the live broadcast platform.

The live broadcast platform receives the first user code, queries whether the first user code is bound to another user code, and if the first user code is bound to another user code, the user code is used as the second user code and sent to the live broadcast assemblies.

The live broadcast assemblies receive the second user code that is sent by the live broadcast platform and bound to the first user code.

In another case, the user previously had the second user code of the live broadcast platform and the live broadcast has already started. After a role of the virtual application is changed, a new user code is generated as a new first user code, where the new first user code is not bound to the second user code. In this case, the live broadcast platform is logged in based on the new first user code.

In this case, if the first user code is a newly generated user code, the live broadcast assemblies can search the mobile terminal for the second user code that previously logged in to the live broadcast platform, use the second user code as a third user code, and send the first user code and the third user code to the live broadcast platform, where the third user code is used for logging in to the live broadcast platform in advance.

Optionally, to reduce the amount of uploaded data, the live broadcast assemblies may send the third user code that previously logged in to the live broadcast platform to the live broadcast platform every time the third user code logs in to the live broadcast platform.

The live broadcast platform receives the first user code and the third user code and queries whether the first user code is bound to another second user code. When it is determined that the first user code is bound to the second user code, the third user code is ignored; when it is determined that the first user code is not bound to the second user code, the third user code is used as the second user code and bound to the first user code even if the third user code becomes a new second user code, and the second user code is sent to the live broadcast assemblies.

The live broadcast assemblies receive the second user code that is sent by the live broadcast platform and bound to the first user code, where the second user code is the third user code.

If each role is bound to a user code of the live broadcast platform, it means that the same user has a large number of user codes of the live broadcast platform, which wastes resources of the live broadcast platform.

In the embodiments of the present application, the third user code that previously logged in to the live broadcast platform and the first user code of the virtual application are sent to the live broadcast platform, and the live broadcast platform binds the first user code to the third user code so that the third user code continues to become the new second user code, and multiple first user codes share the same second user code, thereby saving the resources of the live broadcast platform. Moreover, the third user code has been used for the live broadcast, that is, the third user code has passed identity authentication, and the third user code is directly reused so that repeated identity authentication of the user due to newly added user codes can be avoided, thereby improving the simplicity of a live broadcast operation.

In another case, the user previously had the second user code of the live broadcast platform and the live broadcast has already started. After the virtual application is changed, a new first user code is generated, where the new first user code is not bound to the second user code. In this case, the live broadcast platform is logged in based on the new first user code.

In this case, the live broadcast assemblies can search the mobile terminal for the third user code that previously logged in to the live broadcast platform and send the first user code and the third user code to the live broadcast platform, where the third user code is used for logging in to the live broadcast platform in advance.

The live broadcast assemblies can generate a prompt interface to prompt the user to retrieve the previous second user code. The user enters first user information such as name, identification card, and mobile phone number according to the prompt. In this case, the live broadcast assemblies can receive the first user information and send the first user information to the live broadcast platform.

After receiving the first user information, the live broadcast platform compares the first user information with second user information used for registering the second user code. If the two match, the first user code and the second user code may be bound and the second user code is sent to the live broadcast assembly.

The live broadcast assembly receives the second user code returned by the live broadcast platform, where the second user information used for registering the second user code matches the first user information.

In the embodiments of the present application, the second user code previously registered is associated with user information. The second user code has been registered, that is, the second user code has passed the identity authentication, and the second user code is directly reused so that the newly added user codes can be avoided and thus the repeated identity authentication of the user due to the newly added user codes can be avoided, thereby improving the simplicity of the live broadcast operation.

In S103, the live broadcast platform is logged in according to the second user code, so as to open a live broadcast room bound to the second user code.

If the live broadcast assemblies receive the second user code, the live broadcast platform (a login server) is logged in based on the second user code, and the live broadcast platform (a live broadcast server) is requested to open the live broadcast room for the user.

If the second user code did not previously open the live broadcast room, the live broadcast room may be allocated and the user is prompted to set parameters of the live broadcast room, such as a type of the live broadcast and a title of the live broadcast. The live broadcast platform opens the live broadcast room according to the parameters of the live broadcast room and binds the same to the second user code.

If the second user code previously opened the live broadcast room and is bound to the live broadcast room, the live broadcast room can be activated.

Optionally, the live broadcast room can be directly bound to a current second user code. In this case, the live broadcast platform may directly open the live broadcast room; and the live broadcast room may also be directly bound to another second user code, where another second user code is directly bound to the current second user code. In this case, the live broadcast platform may query another second user code bound to the current second user code and start the live broadcast room bound with another second user code.

In S104, live broadcast stream data is sent to the live broadcast platform for playing in the live broadcast room.

The live broadcast stream data includes the virtual scene displayed by the virtual application, the first audio data played by the virtual application, and second audio data recorded by a microphone.

In the embodiments of the present application, the virtual application displays the virtual scene at a front end, the live broadcast assemblies execute a screenshot operation according to a preset frame rate, and the virtual scene is recorded as the video data.

At the same time, the live broadcast assemblies can call audio tools provided by operating systems such as MediaRecorder to collect the first audio data generated by the virtual application.

Optionally, the virtual application may also directly call an interface provided by the SDK to send the audio data to the SDK, which is not limited in the embodiments of the present application.

In addition, the mobile terminal is equipped with the microphone (also referred to as a pickup, a sound conducting apparatus, etc.), which is a transducer that converts sound into an electrical signal.

Exemplarily, the microphone may be a built-in microphone of the mobile terminal or may be an external microphone connected to the mobile terminal through manners such as a wired manner and a wireless (such as Bluetooth) manner, which is not limited in the embodiments of the present application.

The virtual application can generate one channel of audio data (that is, the first audio data), and when hosting the live broadcast, to explain the operation of the virtual scene and interact with viewers, the user makes a sound. In this case, the live broadcast application can start the microphone of the mobile terminal to collect the sound made by the user, so as to form another channel of audio data (that is, the second audio data).

The collected audio data (including the first audio data and the second audio data) is mostly raw data such as pulse code modulation (PCM). The SDK may call an encoder to mix and encode the audio data (including the first audio data and the second audio data), so as to form a specified audio format such as advanced audio coding (AAC).

The collected video data is mostly raw data such as YUV data (Y denotes luminance, U denotes chrominance, and V denotes chroma). The SDK may call the encoder to encode the video data into a specified video format such as H.264 (digital video compression format).

Thereafter, the SDK may call a packager to encapsulate the audio data (including the first audio data and the second audio data) of the specified audio format and the video data of the specified video format into a live broadcast stream data of a specified stream format such as moving picture experts group 4 (MP4) and flash video (FLV).

The live broadcast assemblies may send the live broadcast stream data to the live broadcast platform (the live broadcast server) through a real time streaming protocol (RTSP), a real time messaging protocol (RTMP), HTTP live streaming (HLS), a streaming media transmission protocol based on a hyper text transport protocol (HTTP), and other protocols, and the live broadcast platform (the live broadcast server) publicizes the live broadcast room so that viewer users can open the live broadcast room in a client and receive the live broadcast stream data for playing.

In the embodiments of the present application, the first user code is generated for the virtual application, the second user code bound to the first user code is acquired from the live broadcast platform, the live broadcast platform is logged in according to the second user code, so as to open the live broadcast room bound to the second user code, and the live broadcast stream data is sent to the live broadcast platform for playing in the live broadcast room. The live broadcast stream data includes the virtual scene displayed by the virtual application, the first audio data played by the virtual application, and the second audio data recorded by the microphone. Live broadcast assemblies are embedded in the virtual application and can run when the virtual application runs, and the live broadcast can be carried out without installing an independent live broadcast application. It is easy to operate. When resources are relatively tight, the live broadcast can be avoided from being shut down by the operating system to ensure that the live broadcast is continuous and uninterrupted. Moreover, the first user code of the virtual application is bound to the second user code of the live broadcast platform so that after the first user code is determined, the second user code can be automatically logged in, and the user does not need to manually log in to the live broadcast platform, thereby improving the simplicity of the live broadcast operation.

### Embodiment Two

FIG. 2 is a flowchart of a live broadcast method according to embodiment two of the present application. This embodiment is based on the preceding embodiment and processing operations of collection of the audio data by the microphone, display of live broadcast room data, pause of the live broadcast, and stop of the live broadcast are added. The method includes steps described below.

In S201, a first user code is generated for the virtual application.

In S202, a second user code is acquired from the live broadcast platform.

The first user code is bound to the second user code.

In S203, second user information is received.

The second user information includes name, identification card, mobile phone number, etc. and is used for registering the second user code for the live broadcast platform in the case where the identity authentication is successful.

In general, to carry out the live broadcast on the live broadcast platform, the identity authentication is required so that users with certain identities are prohibited from hosting the live broadcast. For example, minors are prohibited from hosting the live broadcast of games.

If the user sets up the live broadcast for the first time, the live broadcast assemblies may call identity authentication services provided by a third-party application such as a payment application and an instant messaging tool to execute the identity authentication.

After the identity authentication is successful, the live broadcast assemblies may request the live broadcast platform to register the second user code by using the second user information.

In S204, the live broadcast platform is requested to allocate a live broadcast room.

The live broadcast room is bound to the second user code.

After the registration is successful, the live broadcast assemblies can request the live broadcast platform to allocate the live broadcast room for the second user code. The user sets the parameters of the live broadcast, such as a type of the live broadcast and a title of the live broadcast. The live broadcast platform opens the live broadcast room according to the parameters of the live broadcast room and binds the live broadcast room to the second user code.

In S205, the live broadcast platform is logged in according to the second user code, so as to open a live broadcast room bound to the second user code.

In S206, live broadcast stream data is sent to the live broadcast platform for playing in the live broadcast room.

The live broadcast stream data includes the virtual scene displayed by the virtual application, the first audio data played by the virtual application, and the second audio data recorded by the microphone.

### Embodiment Three

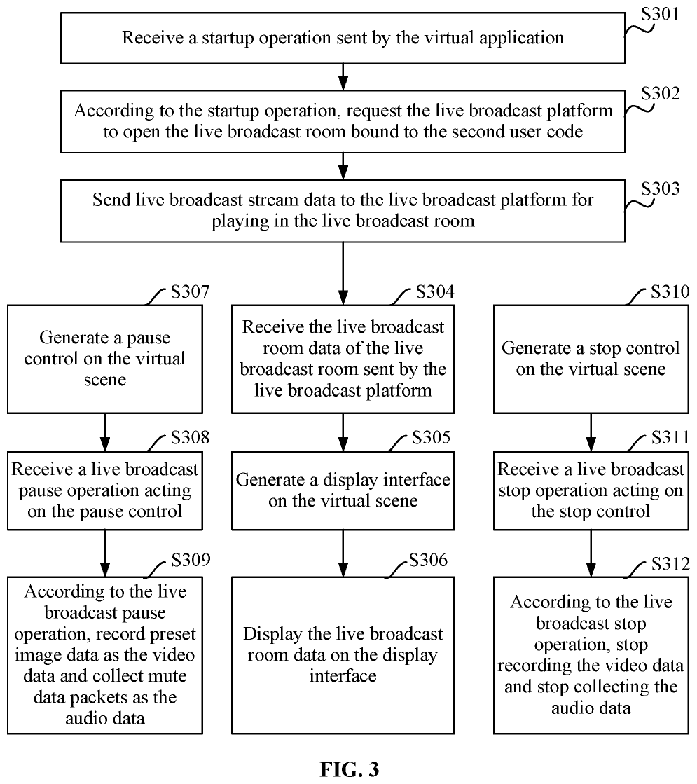

FIG. 3 is a flowchart of a live broadcast method according to embodiment three of the present application. The embodiment of the present application is based on the preceding embodiments and may be applied to a scene where the SDK implements the live broadcast, and processing operations of display of the live broadcast room data, pause of the live broadcast, and stop of the live broadcast are added. Optionally, the embodiment of the present application may be applied to not only the DDK, but also other live broadcast assemblies, which is not limited in the embodiment of the present application.

As shown in FIG. 3, the method includes steps described below.

In S301, a startup operation sent by the virtual application is received.

In the embodiments of the present application, the software development kit (SDK) may be a set of tools configured to execute service operations related to live broadcast, for example, display of an interface related to the start of the live broadcast, floating windows, audio and video encoding and streaming, and other functional modules.

After functional module development work is completed, to facilitate the introduction and docking of the virtual application, the functional modules are packaged into a form of the SDK.

Android is used as an example. Packaging generally includes processes described below.

(1) All development module configurations are traversed in an Android development environment, external libraries that the development module configurations depend on are obtained, and all the external libraries are downloaded to a local designated folder.

(2) All local codes, configurations, and resources in a project are packaged in a format of an Android archive (aar), which is a library packaging file format of an Android platform and includes resources, code, and configurations.

(3) Local and external libraries are combined together, and extraction is executed so that a Java archive (jar) that generally includes only codes, resources, and configurations are obtained and put in a SDK library project.

(4) Grouping is executed according to functional modules, related ones are categorized and merged, redundant jars are deleted, and conflicts of duplication or incompatibility of naming are solved.

The SDK provides multiple interfaces for the virtual application to call.

After the virtual application is started, if the user intends to broadcast an operation in the virtual application, the interfaces provided by the SDK may be called to send the startup operation to the SDK.

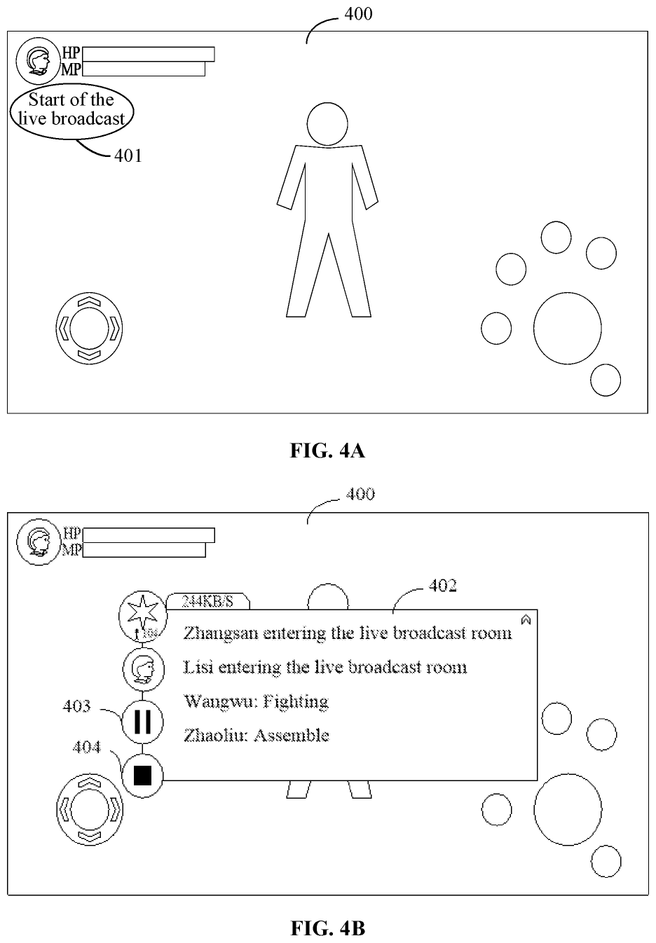

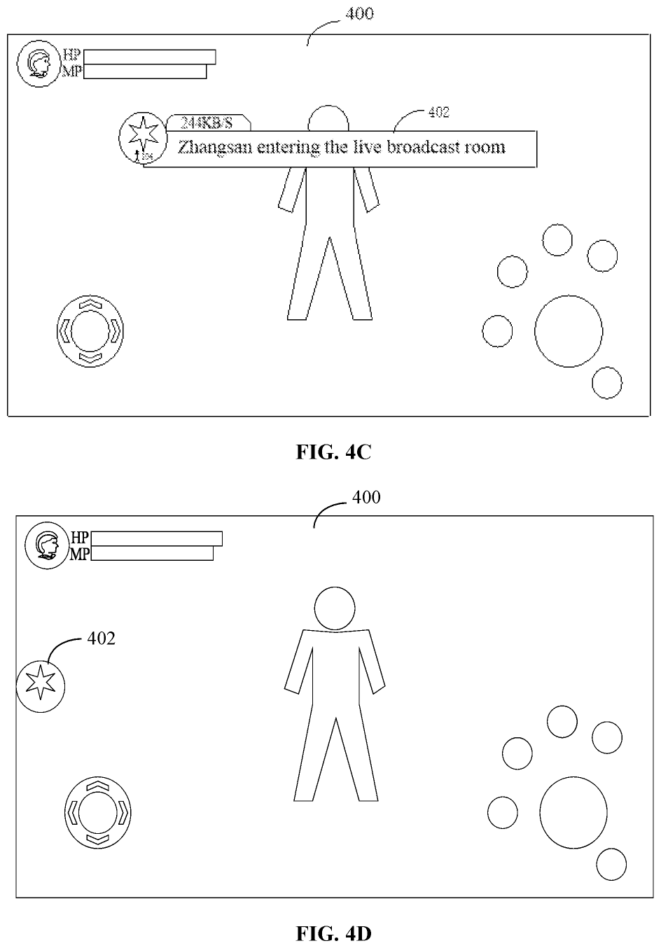

In an example, as shown in FIG. 4A, one live broadcast control 401 is displayed in a virtual scene 400, and an anchor user may trigger the live broadcast control 401 by clicking or the like, thereby generating the startup operation.

In S302, according to the startup operation, the live broadcast platform is requested to open the live broadcast room bound to the second user code.

The second user code is bound to the first user code, the second user code is configured to identify a user of the live broadcast platform, and the first user code is configured to identify a user of the virtual application.

In the embodiments of the present application, the SDK generates the first user code for the virtual application in response to the startup operation.

Exemplarily, the SDK receives the application identifier of the virtual application and the role identifier of the role in the virtual application sent by the virtual application and generates the first user code belonging to the virtual application by using the application identifier and the role identifier.

Thereafter, the SDK logs in to the live broadcast platform according to the second user code, so as to open the live broadcast room bound to the second user code.

In S303, live broadcast stream data is sent to the live broadcast platform for playing in the live broadcast room.

After the live broadcast room is opened, the software development kit (SDK) collects the virtual scene displayed by the virtual application, the first audio data played by the virtual application, and the second audio data recorded by the microphone and packages the virtual scene (the video data), the first audio data, and the second audio data into the live broadcast stream data, that is, the live broadcast stream data includes the virtual scene displayed by the virtual application, the first audio data played by the virtual application, and the second audio data recorded by the microphone.

The live broadcast stream data is sent to the live broadcast platform for playing the live broadcast stream data in the live broadcast room.

In S304, the live broadcast room data of the live broadcast room sent by the live broadcast platform is received.

In S305, a display interface is generated on the virtual scene.

In S306, the live broadcast room data is displayed on the display interface.

When the user hosts the live broadcast in the live broadcast room, the live broadcast platform (the live broadcast server) collects the live broadcast room data in the live broadcast room, such as LOGO of the live broadcast platform, a room number, the number of people online, a bandwidth value, a bullet screen, and virtual gifts.

The live broadcast platform (the live server) sends the live broadcast room data to the SDK, and the SDK receives and caches the live broadcast room data. As shown in FIG. 4B, on the virtual scene 400 of the virtual application, a floating window is generated in which a display interface 402 is generated, that is, the display interface is a user interface belonging to the SDK.

A display position is set for each type of live broadcast room data in the display interface 402.

After the type of live broadcast room data is determined, the display position corresponding to the type is searched, and the live broadcast room data is displayed at the display position.

As shown in FIG. 4C, to prevent the display interface from affecting the anchor user's operation on the virtual scene, if the SDK receives a zoom out operation for the display interface, the display interface 402 may be reduced to a first region interface, that is, an area of the first region interface is less than an area of the display interface, and the first region interface is configured to display part of information such as LOGO of the live broadcast platform, the number of people online, the bandwidth value, and the bullet screen.

If the mobile terminal receives a drag operation acting on the display interface, the display interface may be dragged according to the drag operation such that display continues at a suitable position, thereby avoiding affecting the anchor user's operation on the virtual scene.

Exemplarily, as shown in FIG. 4D, if the display interface is dragged to a designated region such as an edge of a visible region, the display interface 402 may be reduced to a second region interface, that is, an area of the second region interface is less than the area of the display interface, and the second region interface is configured to display simple information such as LOGO of the live broadcast platform.

Generally, the area of the second region interface is less than the area of the first region interface.

In S307, a pause control is generated on the virtual scene.

In S308, a live broadcast pause operation acting on the pause control is received.

In S309, according to the live broadcast pause operation, preset image data is recorded as the video data and mute data packets are collected as the audio data.

The SDK may generate a floating window on the virtual scene of the virtual application and generate the pause control in the floating window, that is, the pause control is an operation control belonging to the SDK.

Optionally, the pause control may be in the same floating window as the display interface and a stop control or may be in an independent floating window, which is not limited in the embodiments of the present application.

If the anchor user is inconvenient to host the live broadcast in a short time, such as answering a phone call or drinking water, the pause control may be triggered by clicking or long pressing, thereby generating the live broadcast pause operation.

When receiving the live broadcast pause operation, the SDK may record the image data as the video data, collect the mute data packets as the audio data, package the video data and the audio data into the live broadcast stream data, and send the live broadcast stream data to the live broadcast platform, so as to play in the live broadcast room (that is, continue to execute S303).

In this case, the client of the viewer users receives and plays the live broadcast stream data, and a displayed screen is the image data and is at a mute state.

If the pause control may be in the same floating window as the display interface, when the display interface is reduced to the first region interface or the second region interface, the display of the pause control may be cancelled or kept, which is not limited in the embodiments of the present application.

In S310, a stop control is generated on the virtual scene.

In S311, a live broadcast stop operation acting on the stop control is received.

In S312, according to the live broadcast stop operation, recording of the video data is stopped and collecting of the audio data is stopped.

The SDK may generate a floating window on the virtual scene of the virtual application and generate the stop control in the floating window, that is, the stop control is an operation control belonging to the SDK.

Optionally, the stop control may be in the same floating window as the display interface and the pause control or may be in an independent floating window, which is not limited in the embodiments of the present application.

If the anchor user ends the live broadcast, such as ending the multiplayer real-time battle, the stop control may be triggered by clicking or long pressing, thereby generating the live broadcast stop operation.

When receiving the live broadcast stop operation, the software development kit (SDK) may stop recording the video data and stop collecting the audio data, so as to stop packaging the video data and the audio data into the live broadcast stream data and stop sending the live broadcast stream data to the live broadcast platform (that is, stop executing S303).

In this case, the client of the viewer users displays that the anchor user is not online.

If the stop control may be in the same floating window as the display interface, when the display interface is reduced to the first region interface or the second region interface, the display of the stop control may be cancelled or kept, which is not limited in the embodiments of the present application.

The preceding user operations are just examples. During the implementation of the embodiments of the present application, other user operations may be set according to actual conditions, such as modifying user information and adjusting resolution, which are not limited in the embodiments of the present application. In addition, in addition to the preceding user operations, those skilled in the art may also adopt other user operations according to actual requirements, which is not limited in the embodiments of the present application.

In the embodiments of the present application, the live broadcast room data, the pause control, the stop control, etc. are displayed on the virtual scene so that the anchor user can conveniently control the virtual scene and host the live broadcast at the same time, thereby improving the simplicity of the live broadcast operation.

### Embodiment Four

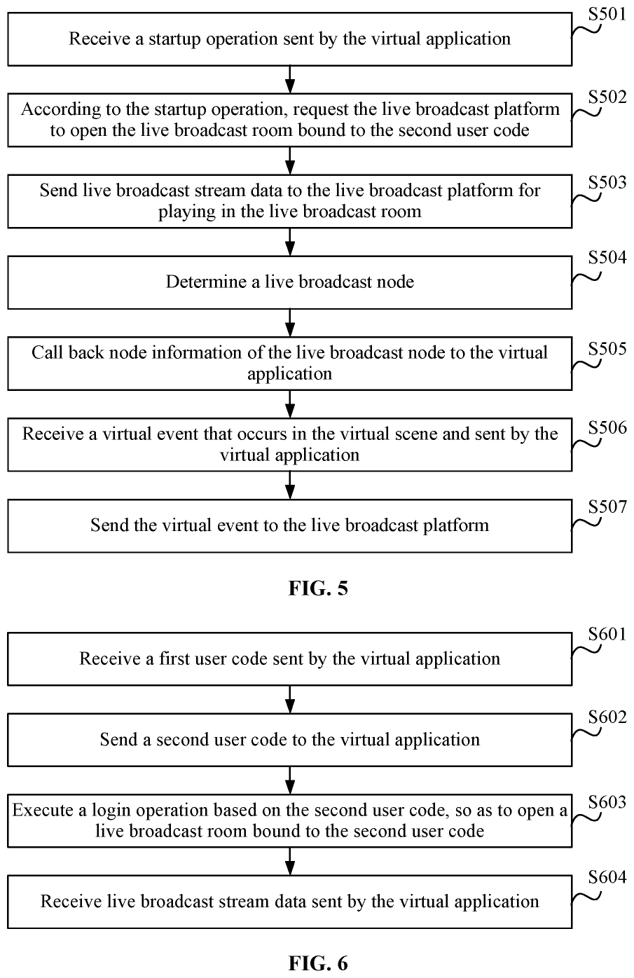

FIG. 5 is a flowchart of a live broadcast method according to embodiment four of the present application. This embodiment is based on the preceding embodiments and an interactive operation of the SDK and the virtual application is added. The method includes steps described below.

In S501, a startup operation sent by the virtual application is received.

In S502, according to the startup operation, the live broadcast platform is requested to open the live broadcast room bound to the second user code.

In S503, live broadcast stream data is sent to the live broadcast platform for playing in the live broadcast room.

The live broadcast stream data includes the virtual scene displayed by the virtual application, the first audio data played by the virtual application, and the second audio data recorded by the microphone.

In S504, a live broadcast node is determined.

In S505, node information of the live broadcast node is called back to the virtual application.

In the embodiments of the present application, the SDK sets a callback function of the virtual application (a main process), and the SDK determines a current live broadcast node (such as live broadcast initialization, user login, user logout, live broadcast start, during the live broadcast, live broadcast pause, and live broadcast end) and calls the callback function to notify the virtual application (the main process) of the live broadcast node.

After receiving the live broadcast node, according to the logic of the virtual application (the main process), the virtual application (the main process) may ignore the live broadcast node or may execute a virtual service processing corresponding to the live broadcast node. For example, when the live broadcast node is the user login, the game frame rate is increased and other processes are cleaned up; when the live broadcast node is the live broadcast pause, value-added information of the game such as the skin is displayed.

In S506, a virtual event that occurs in the virtual scene and sent by the virtual application is received.

In S507, the virtual event is sent to the live broadcast platform.

In the embodiments of the present application, when a specified virtual event occurs in the virtual scene, such as a continuous defeat event (in the multiplayer real-time battle, a user-controlled virtual role continuously defeats N (N is a positive integer such as 5) other user-controlled virtual roles), the virtual application may call the interface provided by the SDK to send the virtual event to the SDK.

The SDK sends the virtual event to the live broadcast platform. After receiving the virtual event, according to the logic of the live broadcast platform, the live broadcast platform may ignore the virtual event or may execute a live broadcast service processing corresponding to the virtual event on the live broadcast stream data. For example, when the virtual event is a continuous defeat event, in the live broadcast stream data, the virtual role controlled by the anchor user is highlighted (such as increasing the brightness or flashing lights).

In the embodiments of the present application, the software development kit may call back the live broadcast node to the virtual application, and the virtual application may notify the software development kit of the virtual event so that data in the live broadcast platform can communicate with data in the virtual application, which is convenient for the virtual application to execute a virtual service operation and for the live broadcast platform to execute a live broadcast service operation, thereby enhancing the functionality and interactivity of the live broadcast and ensuring the consistency of life cycles of the live broadcast and the virtual scene.

### Embodiment Five

FIG. 6 is a flowchart of a live broadcast method according to embodiment five of the present application. The embodiments of the present application may be applied to the live broadcast platform. The live broadcast platform may be an independent server or a cluster of servers, such as a distributed system including a login server, a live broadcast server, etc. The method may be executed by a live broadcast apparatus. The live broadcast apparatus may be implemented by software and/or hardware and may be configured in the live broadcast platform to provide corresponding live broadcast services to the virtual application. The method includes steps described below.

In S601, a first user code sent by the virtual application is received.

The virtual application is configured to display a virtual scene and play first audio data, and the first user code belongs to the virtual application.

In an example, the first user code includes an application identifier of the virtual application and a role identifier of a role in the virtual application.

In S602, a second user code is sent to the virtual application.

The second user code belongs to the live broadcast platform, and the first user code is bound to the second user code.

In a case, after receiving the first user code of the virtual application, the live broadcast platform searches for the second user code bound to the first user code and sends the second user code to the virtual application.

In another case, the live broadcast platform receives a third user code sent by the virtual application when the first user code is a newly generated user code, where the third user code is used for logging in to the live broadcast platform in advance.

When determining that the first user code is not bound to the second user code, the live broadcast platform may use the third user code as the second user code, bind the same to the first user code, and send the second user code to the virtual application.

In another case, the live broadcast platform receives first user information sent by the virtual application and searches for the second user code, where second user information used for registering the second user code matches the first user information, the first user code is bound to the second user code, and the second user code is sent to the virtual application.

In S603, a login operation is executed based on the second user code, so as to open a live broadcast room bound to the second user code.

In an embodiment of the present application, after S603, the live broadcast platform may receive the second user information. The second user information is used for registering the second user code in the case where the identity authentication is successful and binding the live broadcast room to the second user code.

In S604, live broadcast stream data sent by the virtual application is received.

The live broadcast stream data includes the virtual scene displayed by the virtual application, the first audio data played by the virtual application, and second audio data recorded by a microphone and the live broadcast stream data is used for playing in the live broadcast room.

In the embodiments of the present application, since the application is basically similar to the applications in embodiments one to four, the description is relatively simple. For related parts, reference may be made to part of the description in embodiments one to four, which will not be described in detail in the embodiment of the present application.

### Embodiment Six

FIG. 7 is a structure diagram of a live broadcast apparatus according to embodiment six of the present application. The live broadcast apparatus is applied to a virtual application. The virtual application is configured to display a virtual scene and play first audio data. The apparatus may include a first user code generation module 701, a second user code acquisition module 702, a live broadcast platform login module 703, and a live broadcast stream data sending module 704.

The first user code generation module 701 is configured to generate a first user code for the virtual application.

The second user code acquisition module 702 is configured to acquire a second user code from a live broadcast platform, where the first user code is bound to the second user code.

The live broadcast platform login module 703 is configured to log in to the live broadcast platform according to the second user code, so as to open a live broadcast room bound to the second user code.

The live broadcast stream data sending module 704 is configured to send live broadcast stream data to the live broadcast platform for playing in the live broadcast room, where the live broadcast stream data includes the virtual scene displayed by the virtual application, the first audio data played by the virtual application, and second audio data recorded by a microphone.

In an embodiment of the present application, the first user code generation module 701 includes an identifier determination submodule and an identifier generation submodule.

The identifier determination submodule is configured to determine an application identifier of the virtual application and a role identifier of a role in the virtual application.

The identifier generation submodule is configured to generate the first user code belonging to the virtual application by using the application identifier and the role identifier.

In an embodiment of the present application, the second user code acquisition module 702 includes a first sending submodule and a first receiving submodule.

The first sending submodule is configured to send the first user code to the live broadcast platform.

The first receiving submodule is configured to receive the second user code that is sent by the live broadcast platform and is bound to the first user code.

In an embodiment of the present application, the second user code acquisition module 702 includes a user code searching submodule, a second sending submodule, and a second receiving submodule.

The user code searching submodule is configured to search for a third user code in the condition where the first user code is a newly generated user code, where the third user code is used for logging in to the live broadcast platform in advance.

The second sending submodule is configured to send the first user code and the third user code to the live broadcast platform, where the live broadcast platform is configured to use the third user code as the second user code and bind the same to the first user code in the case where it is determined that the first user code is not bound to the second user code.

The second receiving submodule is configured to receive the second user code sent by the live broadcast platform.

In an embodiment of the present application, the second user code acquisition module 702 includes a first user information receiving submodule, a user information sending submodule, and a third receiving submodule.

The first user information receiving submodule is configured to receive first user information.

The user information sending submodule is configured to send the first user information to the live broadcast platform.

The third receiving submodule is configured to receive the second user code returned by the live broadcast platform, where second user information used for registering the second user code matches the first user information.

In an embodiment of the present application, the apparatus further includes a second user information receiving module and a live broadcast room request module.

The second user information receiving module is configured to receive the second user information, where the second user information is used for registering the second user code in the case where identity authentication is successful.

The live broadcast room request module is configured to request the live broadcast platform to allocate the live broadcast room, where the live broadcast room is bound to the second user code.

In an embodiment of the present application, the apparatus further includes a live broadcast room data receiving module, a display interface generation module, and a live broadcast room data display module.

The live broadcast room data receiving module is configured to receive live broadcast room data of the live broadcast room sent by the live broadcast platform.

The display interface generation module is configured to generate a display interface on the virtual scene.

The live broadcast room data display module is configured to display the live broadcast room data in the display interface.

In an embodiment of the present application, the apparatus further includes a pause control generation module, a live broadcast pause operation receiving module, and a pause collection module.

The pause control generation module is configured to generate a pause control on the virtual scene.

The live broadcast pause operation receiving module is configured to receive a live broadcast pause operation acting on the pause control.

The pause collection module is configured to, according to the live broadcast pause operation, record preset image data as video data and collect mute data packets as audio data.

In an embodiment of the present application, the apparatus further includes a stop control generation module, a live broadcast stop operation receiving module, and an audio and video stop collection module.

The stop control generation module is configured to generate a stop control on the virtual scene.

The live broadcast stop operation receiving module is configured to receive a live broadcast stop operation acting on the stop control.

The audio and video stop collection module is configured to stop recording the video data and stop collecting the audio data according to the live broadcast stop operation.

In an embodiment of the present application, the apparatus further includes a live broadcast node determination module and a live broadcast node callback module.

The live broadcast node determination module is configured to determine a live broadcast node.

The live broadcast node callback module is configured to call back node information of the live broadcast node to the virtual application.

In an embodiment of the present application, the apparatus further includes a virtual event receiving module and a virtual event sending module.

The virtual event receiving module is configured to receive a virtual event that occurs in the virtual scene and sent by the virtual application by calling an interface of the software development kit.

The virtual event sending module is configured to send the virtual event to the live broadcast platform.

The live broadcast apparatus provided in the embodiments of the present application may execute the live broadcast method of any one of the embodiments of the present application and has functional modules and beneficial effects corresponding to the executed method.

### Embodiment Seven

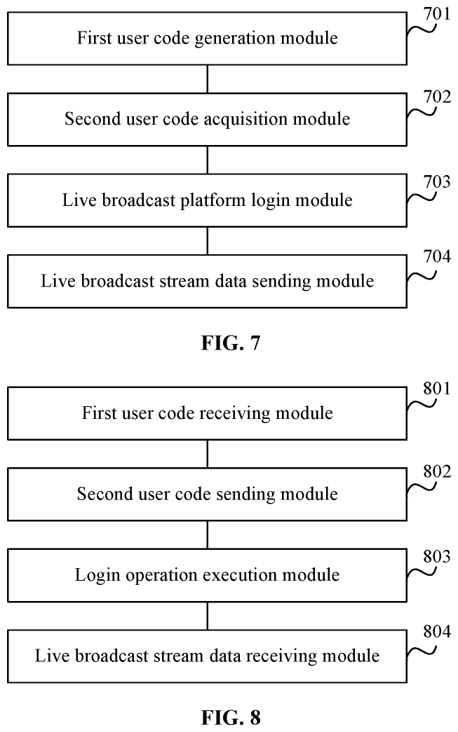

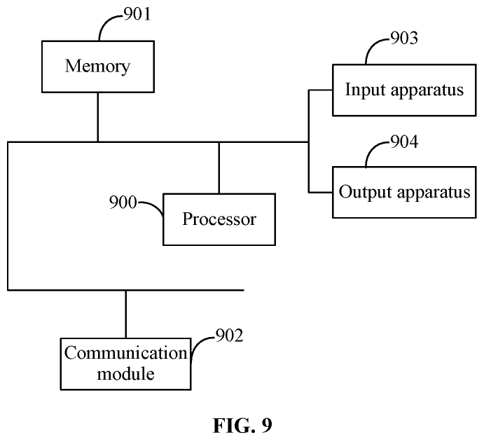

FIG. 8 is a structure diagram of a live broadcast apparatus according to embodiment seven of the present application. The live broadcast apparatus is applied to a live broadcast platform and may include a first user code receiving module 801, a second user code sending module 802, a login operation execution module 803, and a live broadcast stream data receiving module 804.

The first user code receiving module 801 is configured to receive a first user code sent by a virtual application, where the virtual application is configured to display a virtual scene and play first audio data, and the first user code belongs to the virtual application.

The second user code sending module 802 is configured to send a second user code to the virtual application, where the second user code belongs to the live broadcast platform, and the first user code is bound to the second user code.

The login operation execution module 803 is configured to execute a login operation based on the second user code, so as to open a live broadcast room bound to the second user code.

The live broadcast stream data receiving module 804 is configured to receive live broadcast stream data sent by the virtual application, where the live broadcast stream data includes the virtual scene displayed by the virtual application, the first audio data played by the virtual application, and second audio data recorded by a microphone, and the live broadcast stream data is used for playing in the live broadcast room.

In an example in the embodiments of the present application, the first user code includes an application identifier of the virtual application and a role identifier of a role in the virtual application.

In an embodiment of the present application, the second user code sending module 802 includes a first searching submodule and a first sending submodule.

The first searching submodule is configured to search for the second user code bound to the first user code.

The first sending submodule is configured to send the second user code to the virtual application.

In an embodiment of the present application, the second user code sending module 802 includes a first receiving submodule, a first code binding submodule, and a second sending submodule.

The first receiving submodule is configured to receive a third user code sent by the virtual application when the first user code is a newly generated user code, where the third user code is used for logging in to the live broadcast platform in advance.

The first code binding submodule is configured to use the third user code as the second user code and bind the same to the first user code in the case where it is determined that the first user code is not bound to the second user code.

The second sending submodule is configured to send the second user code to the virtual application.

In another embodiment of the present application, the second user code sending module 802 includes a second receiving submodule, a second searching submodule, a second code binding submodule, and a third sending submodule.

The second receiving submodule is configured to receive first user information sent by the virtual application.

The second searching submodule is configured to search for the second user code, where second user information used for registering the second user code matches the first user information.

The second code binding submodule is configured to bind the first user code to the second user code.

The third sending submodule is configured to send the second user code to the virtual application.

In an embodiment of the present application, the apparatus further includes a register information receiving module and a live broadcast room binding module.

The register information receiving module is configured to receive the second user information, where the second user information is used for registering the second user code in the case where identity authentication is successful.

The live broadcast room binding module is configured to bind the live broadcast room to the second user code.

The live broadcast apparatus provided in the embodiments of the present application may execute the live broadcast method of any one of the embodiments of the present application and has functional modules and beneficial effects corresponding to the executed method.

### Embodiment Eight

FIG. 9 is a structure diagram of a computer device according to embodiment eight of the present application. The computer device includes a mobile terminal and a server. As shown in FIG. 9, this computer device includes a processor 900, a memory 901, a communication module 902, an input apparatus 903, and an output apparatus 904. One or more processors 900 may be disposed in the computer device and one processor 900 is used as an example in FIG. 9. The processor 900, the memory 901, the communication module 902, the input apparatus 903, and the output apparatus 904 in the computer device may be connected by a bus or other modes. Connecting by a bus is used as an example in FIG. 9.

As a computer-readable storage medium, the memory 901 may be configured to store software programs, computer-executable programs, and modules such as a module corresponding to a method in this embodiment (for example, the first user code generation module 701, the second user code acquisition module 702, the live broadcast platform login module 703, and the live broadcast stream data sending module 704 in the live broadcast apparatus shown in FIG. 7; or the first user code receiving module 801, the second user code sending module 802, the login operation execution module 803, and the live broadcast stream data receiving module 804 in the live broadcast apparatus shown in FIG. 8). The processor 900 executes software programs, instructions, and modules stored in the memory 901 to perform various functional applications and data processing of the computer device, that is, to implement one preceding method.

The memory 901 may include a program storage region and a data storage region, where the program storage region may store an operating system and an application program required by at least one function while the data storage region may store data created according to use of the computer device. In addition, the memory 901 may include a high-speed random access memory and may also include a nonvolatile memory such as at least one disk memory, a flash memory, or another nonvolatile solid-state memory. In some examples, the memory 901 may include memories which are remotely disposed with respect to the processor 900 and these remote memories may be connected to the computer device via a network. Examples of the preceding network include, and are not limited to, the Internet, an intranet, a local area network, a mobile communication network and a combination thereof.

The communication module 902 is configured to establish a connection with a display screen and achieve data interaction with the display screen. The input apparatus 903 may be configured to receive inputted digital or character information and generate key signal input related to user settings and function control of the computer device.

The computer device provided in this embodiment can execute the method provided in any embodiment of the present application and has corresponding functions and beneficial effects.

### Embodiment Nine

Embodiment nine of the present application further provides a non-transitory computer-readable storage medium storing a computer program, where the computer program is configured to, when executed by a processor, implement a live broadcast method.

In a case, the live broadcast method is applied to a virtual application, where the virtual application is configured to display a virtual scene and play first audio data; where the method includes steps described below.

A first user code is generated for the virtual application.

A second user code is acquired from a live broadcast platform, where the first user code is bound to the second user code.

The live broadcast platform is logged in according to the second user code, so as to open a live broadcast room bound to the second user code.

Live broadcast stream data is sent to the live broadcast platform for playing in the live broadcast room, where the live broadcast stream data includes the virtual scene displayed by the virtual application, the first audio data played by the virtual application, and second audio data recorded by a microphone.

In another case, the live broadcast method is applied to a live broadcast platform and includes steps described below.

A first user code sent by a virtual application is received, where the virtual application is configured to display a virtual scene and play first audio data, and the first user code belongs to the virtual application.

A second user code is sent to the virtual application, where the second user code belongs to the live broadcast platform, and the first user code is bound to the second user code.

A login operation is executed based on the second user code, so as to open a live broadcast room bound to the second user code.

Live broadcast stream data sent by the virtual application is received, where the live broadcast stream data includes the virtual scene displayed by the virtual application, the first audio data played by the virtual application, and second audio data recorded by a microphone, and the live broadcast stream data is used for playing in the live broadcast room.

In the non-transitory computer-readable storage medium provided in the embodiments of the present application, the computer program implements not only the preceding method operations but also related operations in the live broadcast method provided in any one of the embodiment of the present application.

From the preceding description of embodiments, it will be apparent to those skilled in the art that the present application may be implemented by means of software and necessary general-purpose hardware or may be implemented by hardware, but in many cases, the former is a preferred embodiment. Based on this understanding, the technical solutions provided by the present application substantially, or the part contributing to the related art, may be embodied in the form of a software product. The computer software product is stored in the computer-readable storage medium such as a computer floppy disk, a read-only memory (ROM), a random access memory (RAM), a flash, a hard disk, or an optical disk and includes multiple instructions for enabling a computer device (which may be a personal computer, a server, or a network device) to execute the method according to the embodiments of the present application.

Multiple units and modules included in the embodiments of the live broadcast apparatus are just divided according to functional logic, and the division is not limited to this, as long as corresponding functions can be achieved. In addition, names of multiple functional units are just intended for distinguishing and are not to limit the scope of the embodiments of the present application.

1. A live broadcast method, applied to a virtual application, wherein the virtual application is configured to display a virtual scene and play first audio data;
wherein the method comprises:
generating a first user code for the virtual application;
acquiring a second user code from a live broadcast platform, wherein the first user code is bound to the second user code;
logging in to the live broadcast platform according to the second user code, so as to open a live broadcast room bound to the second user code; and
sending live broadcast stream data to the live broadcast platform for playing in the live broadcast room, wherein the live broadcast stream data comprises the virtual scene displayed by the virtual application, first audio data played by the virtual application, and second audio data recorded by a microphone.

2. The method of claim 1, wherein generating the first user code for the virtual application comprises:
determining an application identifier of the virtual application and a role identifier of a role in the virtual application; and
generating the first user code belonging to the virtual application by using the application identifier and the role identifier.

3. The method of claim 1, wherein acquiring the second user code from the live broadcast platform comprises:
sending the first user code to the live broadcast platform; and
receiving the second user code that is sent by the live broadcast platform and bound to the first user code.

4. The method of claim 1, wherein acquiring the second user code from the live broadcast platform comprises:
in a case where the first user code is a newly generated user code, searching for a third user code, wherein the third user code is configured to log in to the live broadcast platform in advance;
sending the first user code and the third user code to the live broadcast platform, wherein the live broadcast platform is configured to use the third user code as the second user code and bind the third user code to the first user code in a case where it is determined that the first user code is not bound to the second user code; and
receiving the second user code sent by the live broadcast platform.

5. The method of claim 1, wherein acquiring the second user code from the live broadcast platform comprises:
receiving first user information;
sending the first user information to the live broadcast platform; and
receiving the second user code returned by the live broadcast platform, wherein second user information used for registering the second user code matches the first user information.

6. The method of claim 1, further comprising:
receiving second user information, wherein the second user information is used for registering the second user code for the live broadcast platform in a case where identity authentication is successful; and
requesting the live broadcast platform to allocate the live broadcast room, wherein the live broadcast room is bound to the second user code.

7. A live broadcast method, applied to a live broadcast platform, wherein the method comprises:
receiving a first user code sent by a virtual application, wherein the virtual application is configured to display a virtual scene and play first audio data, and the first user code belongs to the virtual application;
sending a second user code to the virtual application, wherein the second user code belongs to the live broadcast platform, and the first user code is bound to the second user code;
executing a login operation based on the second user code, so as to open a live broadcast room bound to the second user code; and
receiving live broadcast stream data sent by the virtual application, wherein the live broadcast stream data comprises the virtual scene displayed by the virtual application, the first audio data played by the virtual application, and second audio data recorded by a microphone, and the live broadcast stream data is used for playing in the live broadcast room.

8. A live broadcast apparatus, applied to a virtual application, wherein the virtual application is configured to display a virtual scene and play first audio data;
wherein the apparatus comprises:
a first user code generation module, configured to generate a first user code for the virtual application;
a second user code acquisition module, configured to acquire a second user code from a live broadcast platform, wherein the first user code is bound to the second user code;
a live broadcast platform login module. configured to log in to the live broadcast platform according to the second user code, so as to open a live broadcast room bound to the second user code; and
a live broadcast stream data sending module configured to send live broadcast stream data to the live broadcast platform for playing in the live broadcast room, wherein the live broadcast stream data comprises the virtual scene displayed by the virtual application, the first audio data played by the virtual application, and second audio data recorded by a microphone.

9. A live broadcast apparatus, applied to a live broadcast platform, wherein the apparatus comprises a processor and a memory storing processor-executable instructions which, when executed by the processor, are configured to implement the method of claim 7.

10. A computer device, comprising a memory, a processor, and a computer program stored in the memory and executable by the processor; wherein the processor executes the computer program to implement the live broadcast method of claim 1.

11. A non-transitory computer-readable storage medium storing a computer program, wherein the computer program is configured to, when executed by a processor, implement the live broadcast method of claim 1.

12. The method of claim 2, further comprising:
receiving second user information, wherein the second user information is used for registering the second user code for the live broadcast platform in a case where identity authentication is successful; and
requesting the live broadcast platform to allocate the live broadcast room, wherein the live broadcast room is bound to the second user code.

13. The method of claim 3, further comprising:
receiving second user information, wherein the second user information is used for registering the second user code for the live broadcast platform in a case where identity authentication is successful; and
requesting the live broadcast platform to allocate the live broadcast room, wherein the live broadcast room is bound to the second user code.

14. The method of claim 4, further comprising:
receiving second user information, wherein the second user information is used for registering the second user code for the live broadcast platform in a case where identity authentication is successful; and
requesting the live broadcast platform to allocate the live broadcast room, wherein the live broadcast room is bound to the second user code.

15. The method of claim 5, further comprising:
receiving second user information, wherein the second user information is used for registering the second user code for the live broadcast platform in a case where identity authentication is successful; and
requesting the live broadcast platform to allocate the live broadcast room, wherein the live broadcast room is bound to the second user code.

16. A computer device, comprising a memory, a processor, and a computer program stored in the memory and executable by the processor; wherein the processor executes the computer program to implement the live broadcast method of claim 2.

17. A computer device, comprising a memory, a processor, and a computer program stored in the memory and executable by the processor; wherein the processor executes the computer program to implement the live broadcast method of claim 3.

18. A computer device, comprising a memory, a processor, and a computer program stored in the memory and executable by the processor; wherein the processor executes the computer program to implement the live broadcast method of claim 4.

19. A computer device, comprising a memory, a processor, and a computer program stored in the memory and executable by the processor; wherein the processor executes the computer program to implement the live broadcast method of claim 5.

20. A computer device, comprising a memory, a processor, and a computer program stored in the memory and executable by the processor; wherein the processor executes the computer program to implement the live broadcast method of claim 6.
